(19) United States
(12) Patent Application Publication
(10) Pub. No.: US 2013/0144985 A1
(43) Pub. Date: Jun. 6, 2013

(54) TERMINAL, DISTRIBUTION SYSTEM, DISTRIBUTION SERVER, PLAYBACK METHOD, AND PROGRAM

(71) Applicant: Yuzo Senda, Tokyo (JP)

(72) Inventor: Yuzo Senda, Tokyo (JP)

(73) Assignee: NEC CORPORATION, Minato-ku, Tokyo (JP)

(21) Appl. No.: 13/697,688

(22) PCT Filed: Apr. 26, 2011
(86) PCT No.: PCT/JP2011/060117

§ 371 Date: Jan. 8, 2013

(30) Foreign Application Priority Data
May 12, 2010 (JP) 2010-109977

(51) Int. Cl. H04L 29/08

(52) U.S. Cl. CPC H04L 67/02
USPC 709/219

(57) ABSTRACT

Disclosed is a technology which eliminates distribution modality choices that are intrinsically unnecessary, as follows. For each content item on a content list containing identifying information for content to play on a terminal, information on distribution modalities supported by that content item is acquired from a server. On the basis of the acquired distribution-modality information and content playback preparation statuses for each distribution modality, pairs comprising content items in playable states and distribution modalities therefor are searched for, and said content items are played using said distribution modalities.

### TECHNICAL FIELD

The present invention relates to a terminal, a distribution system, a distribution server, a reproduction method, and a program.

### BACKGROUND ART

A progress in digitalization of television broadcasts etc. is underway, and a multi-channel linear service utilizing a satellite and a cable is provided. The linear service is also provided over a network owing to broadbandization of a packet exchange network. Utilizing the multicast technology makes it possible to provide a service at a cost equal to that of a cable television or so without inflicting a load on both of a distribution server and a network.

Thereupon, a video-on-demand (VOD) service using the network to the broadbandization has come onstage. The VOD service, differently from the linear service, enables a user to view video contents selected by itself with a streaming distribution. The so-called streaming distribution is a distribution technique of reproducing the videos while sequentially receiving stream data. Herein, it is assumed that a progressive download distribution technique of acquiring the stream data prior to the video reproduction is also included in the streaming distribution. For example, in a video viewing service of Non-patent literature 1, it is possible to continuously view a plurality of the contents shown in a reproduction list on web browser over a PC. The reproduction of each content is performed with the streaming distribution. The viewer can not only view the contents to its own convenience but also select favorite contents among from multifarious contents because there is no case in which the viewer is fettered to a program formation like the linear service. It is thinkable that users of the VOD service are increased hereafter from a viewpoint of this convenience.

As the video content distribution service other than the linear service and the VOD service, there exists a download distribution service. In the download distribution, the completion of the download of an entirety of the contents is awaited after the contents are selected. Thereafter, the above contents can be reproduced at an arbitrary time. The times required for the download distribution are diversely divided, dependent on a network connection environment of to user; however, there is no possibility that the reproduction is temporarily stopped due to a reason that no data is available at hand because an entirety of the contents are arranged at hand at the time of the reproduction. For example, a communication KARAOKE playing terminal of Patent literature 1 continuously reproduces musical pieces according to a reservation list registered by a user. The reason why the download distribution is performed is that it is not permitted to stop the reproduction of the contents halfway. Performing the download distribution of the contents not existing within the terminal over the reservation list in a mass lot allows a communication cost to be suppressed while reducing a play stopping time.

### CITATION LIST

### Patent Literature

PTL 1: U.S. Pat. No. 4,136,094 (JP-P2004-047672A)
PTL 2: U.S. Pat. No. 4,134,904 (JP-P2005-189611A)

### Non-Patent Literature

NON-PTL 1: http://streaming.yahoo.co.jp

### SUMMARY OF INVENTION

### Technical Problem

The above-mentioned linear service has a constraint that only the contents listed in a program formation can be viewed, and hence, a problem that a freedom degree of the content selection is low notwithstanding a combination of reservation recording etc. Further, the VOD service has a problem that occurs in the course of prevalence of the VOD service, namely, a problem of tightness of network resources and distribution server resources. For example, total traffics of Internet are rapidly increasing, and technological innovation does not catch it, whereby a raise in a utilization charge and a change to a charge system are being investigated. Upon investigating the traffic in details, a peak in the night is conspicuous in recent years, and two times as large as the traffic in the day occurs in the night. Resultantly, this causes a decline in the service quality in the night, for example, a connection to the server cannot be made due to crowdedness of the server, and the reproduction is temporarily stopped due to a delay in reception of the stream data. The VOD service has a problem of a cost and a quality. Further, with the case of the download distribution, convenience is sacrificed some degree so as to secure the video quality. In such a manner, trade-off of the convenience/cost/quality exists with regard to the linear service, the VOD service, and the download service. One method of enhancing satisfaction of the user is to combine the streaming distribution and the download distribution and to realize a composite service. For example, the electronic musical instrument of Patent literature 2 instructs, for individual contents, a utilization form thereof, and selectively uses the download distribution service and the VOD service responding to this instruction.

The original request of the user is to view the interesting videos. In a current situation, however, it is not that the user selects the video, but that the user is forced to select the type of the distribution form or the service. Notwithstanding the selection of the VOD service expecting the convenience of prompt reproduction, the user encounters a decline in the quality such as the temporary stopping of the reproduction, dependent on the network connection environment and the utilization time band of the user.

Thereupon, the present invention has been accomplished in consideration of the above-mentioned problems, and an object of the present invention is to provide the technology of eliminating the selection of the distribution form that is intrinsically unnecessary.

### Means for Solving Problem

The present invention for solving the above-mentioned problems is a terminal characterized in including a retrieval means that acquires from a server information of a distribution form to which each content of a content list in which identification information of the contents to be reproduced in the terminal is shown can correspond, and retrieves a pair of the content that is in a status of being reproducible, and the distribution form thereof, based on the aforementioned acquired information of the distribution form and a situation of reproduction readiness of the contents for each distribution form, and a reproduction means that reproduces the aforementioned retrieved content by employing the aforementioned retrieved distribution form.

The present invention for solving the above-mentioned problems is a distribution system characterized in including a provision means that provides information of a distribution form to which each content of a content list in which identification information of the contents to be reproduced in a terminal is shown can correspond, a retrieval means that acquires from the aforementioned provision means the information of the distribution form to which each content of the aforementioned content list can correspond, and retrieves a pair of the content that is in a status of being reproducible, and the distribution form thereof, based on the aforementioned acquired information of the distribution form and a situation of reproduction readiness of the contents for each distribution form, and a reproduction means that reproduces the aforementioned retrieved content by employing the aforementioned retrieved distribution form.

The present invention for solving the above-mentioned problems is a distribution server characterized in including a provision means that, based on information of a distribution form to which each content of a content list in which identification information of the contents to be reproduced in a terminal is shown can correspond, and a situation of reproduction readiness of the contents for each distribution form, retrieves a pair of the content that is in a status of being reproducible, and the distribution form thereof, and provides at least the information of the distribution form, out of the aforementioned information of the distribution form and the situation of the reproduction readiness of the contents for each distribution form, for the terminal that reproduces the aforementioned retrieved content by employing the aforementioned retrieved distribution form.

The present invention for solving the above-mentioned problems is a reproduction method characterized in including an acquisition step of acquiring from a server information of a distribution form to which each content of a content list in which identification information of the contents to be reproduced in a terminal is shown can correspond, a retrieval step of retrieving a pair of the content that is in a status of being reproducible, and the distribution form thereof, based on the aforementioned acquired information of the distribution form and a situation of reproduction readiness of the contents for each distribution form, and a reproduction step of reproducing the aforementioned retrieved content by employing the aforementioned retrieved distribution form.

The present invention for solving the above-mentioned problems is a program of a terminal characterized in that the aforementioned program causes the aforementioned terminal to execute an acquisition process of acquiring from a server information of a distribution form to which each content of a content list in which identification information of the contents to be reproduced in the terminal is shown can correspond, a retrieval process of retrieving a pair of the content that is in a status of being reproducible, and the distribution form thereof, based on the aforementioned acquired information of the distribution form and a situation of reproduction readiness of the contents for each distribution form, and a reproduction instruction process of instructing a reproduction unit to reproduce the aforementioned retrieved content by employing the aforementioned retrieved distribution form.

The present invention for solving the above-mentioned problems is a program of a server characterized in that the aforementioned program causes the aforementioned server to execute a provision process of, based on information of a distribution form to which each content of a content list in which identification information of the contents to be reproduced in a terminal is shown can correspond, and a situation of reproduction readiness of the contents for each distribution form, retrieving a pair of the content that is in a status of being reproducible, and the distribution form thereof, and providing at least the information of the distribution form, out of the aforementioned information of the distribution form and the situation of the reproduction readiness of the contents for each distribution form, for the terminal that reproduces the aforementioned retrieved content by employing the aforementioned retrieved distribution form.

### Advantageous Effect of Invention

In accordance with the present invention, the user does not need to select the distribution form.

### BRIEF DESCRIPTION OF DRAWINGS

FIG. 1 is a schematic view of an entire configuration of the video content distribution system for which the present invention is carried out.

FIG. 2 is a block diagram illustrating a configuration of a client for which the present invention is carried out.

FIG. 3 shows one example of a reproduction list.

FIG. 4 shows one example of the reproduction list.

FIG. 5 is shows one example of the reproduction list.

FIG. 6 is a flowchart of a content reproduction instruction process to be performed in a control unit 202.

FIG. 7 is a flowchart of a download instruction process to be performed in the control unit 202.

FIG. 8 is a schematic view illustrating a temporal transition with regard to one example of an operation of the client of the present invention.

FIG. 9 is a view for explain a change in a status of the reproduction list.

FIG. 10 is a view for explain a change in a status of the reproduction list.

### DESCRIPTION OF EMBODIMENTS

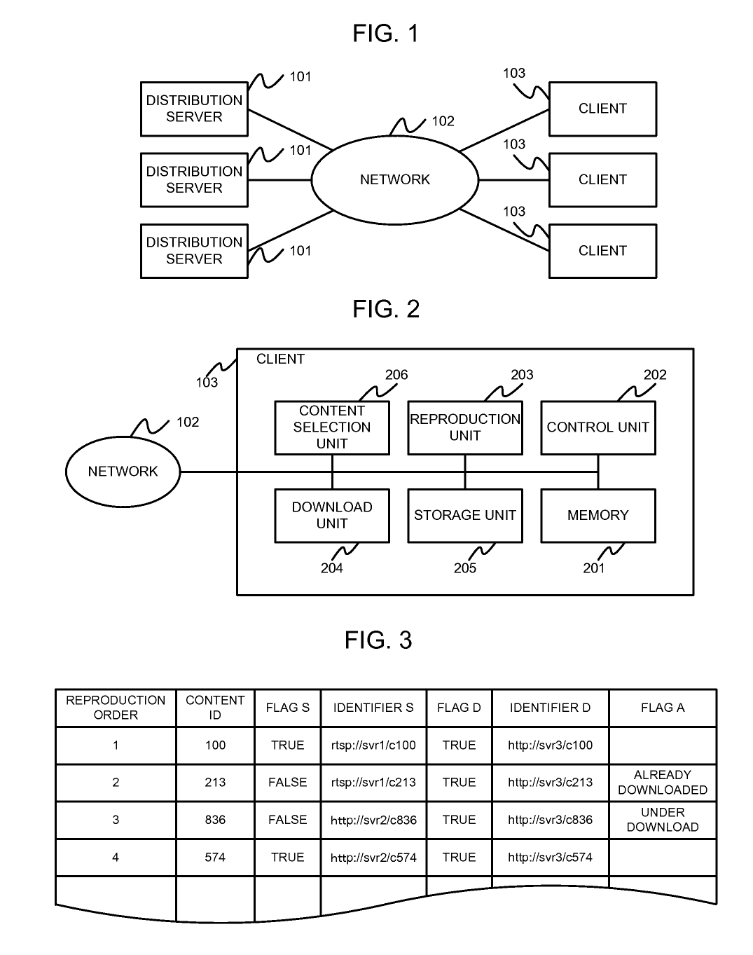

The exemplary embodiments of the present invention will be explained by referencing the accompanied drawings. FIG. 1 is a schematic view of the video content distribution system for which the present invention is carried out. In the video content distribution system, at least one distribution server 101 or more and at least one client 103 or more are connected to a network 102. And, various contents are distributed from the distribution servers 101 to the clients 103. The content to be distributed is multimedia data such as voices, still pictures and moving pictures.

The client 103 of the present invention acquires information of the distribution form to which each content of the reproduction list selected by the user, being a list of the contents to be reproduced in its own device can correspond. And, the client 103 retrieves a pair of the content that is in a status of being reproducible and the distribution form thereof, based on the acquired information of the distribution form and a situation of the reproduction readiness of the content for each distribution form thereof.

Further, continuously reproducing the already downloaded contents or the streamable contents as the reproducible content within the reproduction list allows the VOD service and the download distribution service to be integrated.

With this, the user does not need to select the distribution form. Further, determining whether or not the streaming distribution is possible from a situation of the distribution server resources and the network resources makes it possible to maintain a high-quality service. Even though the streaming distribution becomes impossible, the user can view the already downloaded contents. There is no possibility that the user encounters a decline in the quality in a series of the views.

Hereinafter, the details of the present invention will be explained.

### First Exemplary Embodiment

The first exemplary embodiment of the present invention will be explained.

The client 103 is a general terminal. As shown in FIG. 2, the client 103 includes a memory 201, a control unit 202, a reproduction unit 203, a download unit 204, a storage unit 205, and a content selection unit 206.

The reproduction list selected by employing the content selection unit 206 is stored in the memory 201. One example of the reproduction list is shown in FIG. 3. A content ID and a reproduction order are described in this reproduction list. The content ID is an identification No. for uniquely identifying the content to be reproduced in the client 103. The reproduction order represents a turn in a case of continuously reproducing a plurality of the contents of the reproduction list. However, when the content IDs of the reproduction list are stored in array in the content list according to the reproduction order, No. of the reproduction order is a suffix of the array.

Further, a flag S, a flag D, a flag A, an identifier S, and an identifier D are described as attributes of the content ID in the reproduction list.

The flag S, which indicates whether or not the streaming distribution of the above content is possible, is an information text serving both as the distribution form information and as the reproduction readiness situation. The control unit 202 inquires of the distribution server 101 described in the identifier S of the above content about whether or not the streaming distribution of the content designated in the identifier S is possible, and sets the flag S. When the distribution server 101 has judged that the streaming distribution is possible, “True” is inserted into the flag S, and when the distribution server 101 has judged that the streaming distribution is impossible, “False” is inserted into the flag S.

The flag D indicates whether or not the download distribution is possible as information of the reproduction form of the content. When the content corresponds to the download distribution, “True” is inserted, and when the content does not correspond to the download distribution, “False” is inserted. Flag A indicates the reproduction readiness situation of the content corresponding to the download distribution. When the content is under the download, “Under download” is inserted into the flag A, and when the download to the storage unit 205 has already been ended, “Already downloaded” is inserted into the flag A. “Not set yet” is inserted otherwise.

The identifier S indicates a distribution server name, a communication protocol name, and a content name of the content corresponding to the streaming distribution. In an example of FIG. 3, “rtsp://svr1/c100 is described in the identifier S, and rtsp, svr1, and c100 are the communication protocol name, the distribution server name and the content name, respectively.

The identifier D indicates a distribution server name, a communication protocol name, and a content name of the content corresponding to the download distribution. With “http://svr3/c100 of the identifier D shown in an example of FIG. 3, http, svr3, and c100 are the communication protocol name, the distribution server name and the content name, respectively.

Additionally, the explanation was made, saying that “True” or “False” was inserted into the above-mentioned flag S or flag D; however, other items of information may be inserted so long as they are information for clarifying each status. Likewise, other items of information may be inserted into the flag A as well so long as they are information for clarifying the situation of the reproduction readiness.

When, for the identical content ID, the above contents can be distributed from a plurality of the distribution servers, pairs of the flag S and the identifier S may be incorporated into the content ID in a plural number as the attributes. In this case, the judgment that the reproduction is possible signifies that the flag A of the above content ID is “Already downloaded” and one flag S or more is “True”.

Additionally, the explanation was made by employing the case of describing the flag S, the flag D, the flag A, the identifier S, and the identifier D as the attributes of the content ID in the above-mentioned reproduction list; however, other formats may be used so long as the distribution form of the content, the situation of the reproduction readiness, and a distribution source are clarified. Hereinafter, other examples of the reproduction list will be explained.

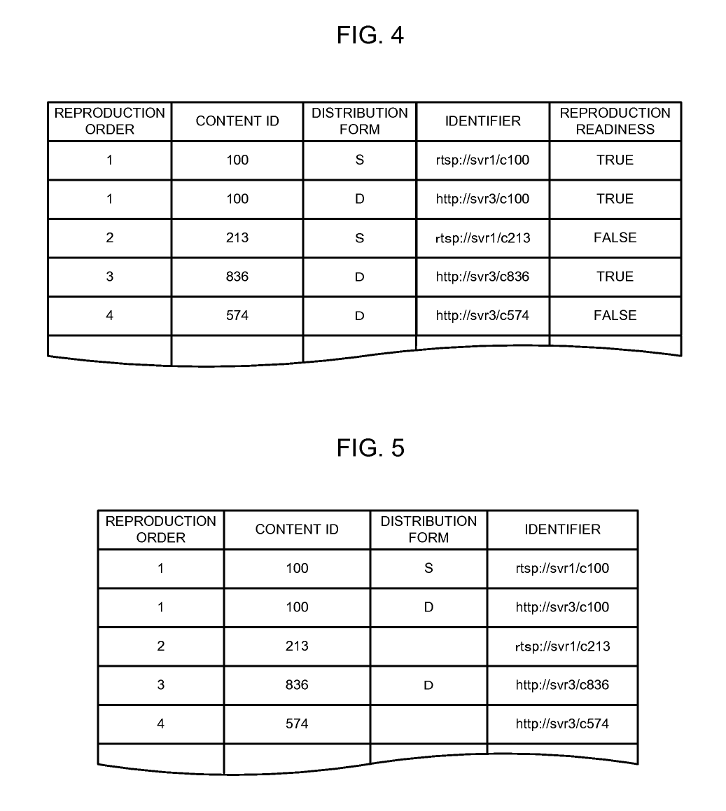

FIG. 4 shows one example of the reproduction list. As the attributes of the content ID, information related to the distribution form of the above content, the identifier, and information related to the reproduction readiness are described in this reproduction list. Additionally, an identifier is identical to that of the reproduction list explained by employing the above-mentioned FIG. 3, so the detailed explanation is omitted.

The information related to the distribution form is information indicating whether or not the streaming distribution or the download distribution is possible. “S” is inserted into the content corresponding to the streaming distribution, and “D” is inserted into the content corresponding to the download distribution. Pairs of the information related to the distribution form, the identifier, and the information related to the reproduction readiness are described in a plural number in the content corresponding to both, as shown in the content ID “100” of FIG. 4. Additionally, the explanation was made, saying that “S” was inserted with the case of the streaming distribution, and “D” was inserted with the case of the download distribution; however, other items of information may be used so long as they are information for clarifying this.

The information related to the distribution readiness is information indicating whether the content is in a status of being reproducible. When the content corresponds to the streaming distribution and the distribution server 101 judges that the streaming distribution is possible, “True” is inserted as the flag, and when the distribution server 101 judges that the streaming distribution is impossible, “False” is inserted. On the other hand, when the content corresponds to the download distribution and the content has already been downloaded into the storage unit 205, “True” is inserted, and when the content has not been downloaded, “False” is inserted.

In addition, another example is shown in FIG. 5. With regard to the reproduction list shown in FIG. 5, when the content comes into a status of being distributable, “S” or “D” indicating the distribution form thereof is inserted into the distribution form of the content that is in a status of being distributable. Additionally, the explanation was made, saying that “S” was inserted with the case of the streaming distribution, and “D” was inserted with the case of the download distribution; however, other items of information may be used so long as they are information for clarifying this.

The control unit 202 references the reproduction list of the memory 201, retrieves a pair of the reproducible content and the distribution form thereof, and performs a content reproduction instruction process. Further, when the distribution form of the content, out of the contents that have not become reproducible, is the download distribution, the control unit 202 performs a download instruction process for it. Additionally, in referencing the flag S, the control unit 202 inquires of the distribution server 101 described in the identifier S of the above content ID about whether or not the streaming distribution of the content designated by the identifier S is possible, and sets the flag S. In the system in which whether or not the distribution is possible is changed every moment, the control unit 202 inquires whenever it retrieves the reproducible contents. In the system in which whether or not the distribution is possible is changed for every hour, the control unit 202 may inquire when a transition to the next time band from the time band when it inquired last time is made. In the system in which whether or not the streaming distribution is possible is fixed, the control unit 202 may make a setting at the moment of registering the content ID in the reproduction list. Hereinafter, the details of each process will be explained.

The control unit 202 acquires the content ID that should be reproduced next from among the retrieved contents, and gives an instruction to the reproduction unit 203 as the content reproduction instruction process. For example, the content of which the flag S is “True” indicates that the streaming distribution thereof is possible, and also signifies that the reproduction readiness has been arranged, whereby the control unit 202 defines the above content as the content that should be reproduced. Additionally, when the reproduction order has been decided, the control unit 202 retrieves the reproducible contents according to the reproduction order. Further, the reproduction order in a case in which the reproduction order has not been decided and the reproducible contents are present in a plural number maybe appropriately decided.

As the download instruction process, the control unit 202 acquires the content ID that should be downloaded, and gives an instruction to the download unit 204. And, the control unit 202 sets the flag A of the content ID for which an instruction for the download has been given to “Under download”. Additionally, when with regard to the identical content, the download distribution and the streaming distribution of the above content are possible, which distribution may be given a priority. For example, when with regard to the content of which the reproduction order is listed in the second place or the place after it, the download distribution and the streaming distribution of the above content is possible, and the download is possible until the above content is reproduced, the control unit 202 may issue the download instruction process. Further, when the download unit 204 completes the download after the download instruction process, the control unit 202 sets the flag A of the content ID of which the download has been completed to “Already downloaded”. As a method in which the control unit 202 detects the completion of the download, there exist not only the method in which the download unit 204 notifies a download completion message including content ID of which the download has been completed to the control unit 202, but also the method in which the control unit 202 inquires of the download unit 204 about the content ID of which the flag A within the reproduction list is “Under download”, and confirms the completion of the download.

When a download instruction message is notified, the download unit 204 starts the download so as to store the corresponding content in the storage unit 205 according to the identifier D of the content ID within the above message. Incorporating the download list inside the download unit 204 makes it possible to simultaneously perform a plurality of the downloads. Additionally, an upper limit speed of the download may be incorporated into the download unit 204. Additionally, putting a limit to the download speed in such a manner that it is a high bit rate in the day and it is a low bit rate in the night makes it possible to enhance a quality of an entirety of the system because a peak of the network traffic exists in the night. Avoiding a peak can be also accomplished by incorporating an upper limit number of the simultaneous distributions into download unit 204. For example, putting a limit to the upper limit number of the simultaneous distributions in such a manner that it is eight in the day and it is one in the night makes it possible to enhance a quality of an entirety of the system similarly to the case of the upper limit speed.

When the flag A of the content ID for which an instruction for the reproduction has been given is “Already downloaded”, the reproduction unit 203 makes a setting so as to receive a content file corresponding to the above content ID from the storage unit 205. Otherwise, the reproduction unit 203 makes a setting so as to receive corresponding content stream with the streaming distribution according to the identifier S of the above content ID, and decodes and reproduces the received content stream. In a case of having incorporated pairs of the flag S and the identifier S in a plural number as the attributes into the content ID, the reproduction unit 203 makes a setting so as to receive the corresponding content stream with streaming distribution according to the identifier S of the pair of which the flag S is “True”. Additionally, which is given a priority may be appropriately set according to a design when the reproduction is possible with streaming distribution and the download distribution.

So as to perform the continuous reproduction according to the reproduction list, the reproduction unit 203 deletes the content ID of which the reproduction has been ended from the reproduction list at the moment of ending the reproduction of the content, and notifies the control unit 202 that the reproduction has been ended. Further, the control unit 202, upon receipt of a notification saying the ending of the reproduction, executes the content reproduction instruction process. With this scheme, the ending of the reproduction incurs the reproduction of the next content, and the continuous reproduction is performed.

Additionally, as the reproduction order of the contents, there exists the desirable reproduction order like the reproduction order of continuous dramas. In order to reproduce the contents just like that, a dependent content ID is added as the attribute of the content ID. Further, a reproduction history list is previously stored in the memory 201. In the content reproduction instruction process of the control unit 202, it is added as a condition of the selection that, at the moment of acquiring the content ID, the dependent content ID of the above content ID exists in the reproduction history list. And, the setting is made in such a manner that the reproduction is performed in an order for cancelling its dependent relation. This allows the contents to be reproduced in a desirable reproduction order irrespective of the reproduction order within the reproduction list if the dependent content ID is correctly set because the contents are reproduced in an order for cancelling the dependent relation. Further, as another method, the method of rearranging the order described in the reproduction list into the reproduction order may be used. In addition, the method of basically reproducing the contents in the order described in the reproduction list, and reproducing the contents for which the dependent content ID has been set according to the dependent content ID may be used.

The content selection unit 206 provides a user interface of the content selection. The user selects the contents user itself desires to reproduce, or the already set content list. At this time, the content selection unit 206 makes an access to a provision server or the distribution server that provides information related to the contents such as the content name, the content ID, the distribution form of the content, and the identifier of the content, and acquires these items of the information. Additionally, in a case of desiring to incorporate the reproduction order into the reproduction list, the user interface includes a later reproduction button and a prompt reproduction button for each content, and the content selection unit 206 adds the corresponding content ID as a final order rank of the reproduction list in some cased and sets the dependent content ID in some cases when the later reproduction button is pushed by the user. On the other hand, the content selection unit 206 adds the corresponding content ID as a leading order rank to the reproduction list in some cased and sets the dependent content ID in some cases, and together therewith, instructs the reproduction unit 203 to reproduce the above content ID when the prompt reproduction button is pushed. In a case in which the flag S of the content ID becomes “False”, it is desirable to put the prompt reproduction button in a status of non-display.

While in the above-mentioned explanation of the client, the case in which respective configuration units constituted the identical terminal was explained, there is no necessity for one piece type. The client of the present invention may be constituted as a whole by preparing two component housings, performing the memory 201, the control unit 202, the reproduction unit 203 and the input unit 206 in one component housing, performing the download unit 204 and the storage unit 205 in another component housing, and linking two component housings via LAN.

The exemplary embodiment of the client was explained so far. Continuously, the exemplary embodiment of the distribution server will be explained. The distribution server can contribute to solving the problems by having a linkage to the client.

The distribution server 101 determines whether or not the content is in a status suitable for the streaming distribution in consideration of the distribution situation of the contents, a position of the client, and the crowdedness situation of the network when receiving an inquiry as to whether or not the streaming distribution is possible from the control unit 202 of the client 103. The distribution situation of the content is, for example, the number of the terminals receiving the distribution of the above content. The position of the client is a distance between the distribution server and the terminal. The crowdedness situation of the network is a congestion situation between the distribution server and the terminal. In the video content distribution system of the present invention, the download distribution can be utilized as an alternative for the streaming distribution, whereby it can be previously determined that the streaming distribution is impossible before a decline in the quality is incurred due to the distribution that is unreasonable from a viewpoint of the resources.

When the distribution server 101 provides the differentiated service for the user, it acquires a contract condition by performing a certification of the client when receiving an inquiry as to whether or not the streaming distribution is possible, references a value of the current time from a by-time priority described in the contract condition, and determines whether or not the streaming distribution is possible. This makes it possible to guide a free member to view, in the night, the contents downloaded in the day while putting a pay member in a status in which the streaming distribution is possible at any time. As a result, a peak of the traffics in the network and the distribution service can be suppressed.

When the distribution server 101 provides the differentiated service for the content, it references a distribution priority of the content when receiving an inquiry as to whether or not the streaming distribution is possible, and determines whether or not the streaming distribution is possible. This makes it possible to guide commercial propagations and promotional contents so that they are distributed in an appropriate time.

The distribution server 101 can utilize the reproduction list of the client 103 for a future prediction. The client 103 notifies the reproduction list to the distribution server 101, and the distribution server can predict a distribution demand for each content ID from the reproduction list notified from a plurality of the clients. Utilizing this prediction for a distribution plan of the contents makes it possible to put the content in a status in which the streaming distribution is possible before the client starts the reproduction of the above content.

Further, the above prediction is employed for determining whether or not the streaming distribution is possible. For example, by making a response, saying that the distribution is impossible statistically even though the distribution is possible when the distribution demand exceeds a distribution capability, a peak of a distribution demand for a certain content ID can be dispersed.

The present invention is not limited to the distribution of the video contents. The present invention may be carried out for the audio content distribution only changing the wording from the video content to the audio content.

Next, an example of an operation of the client of the present invention will be explained.

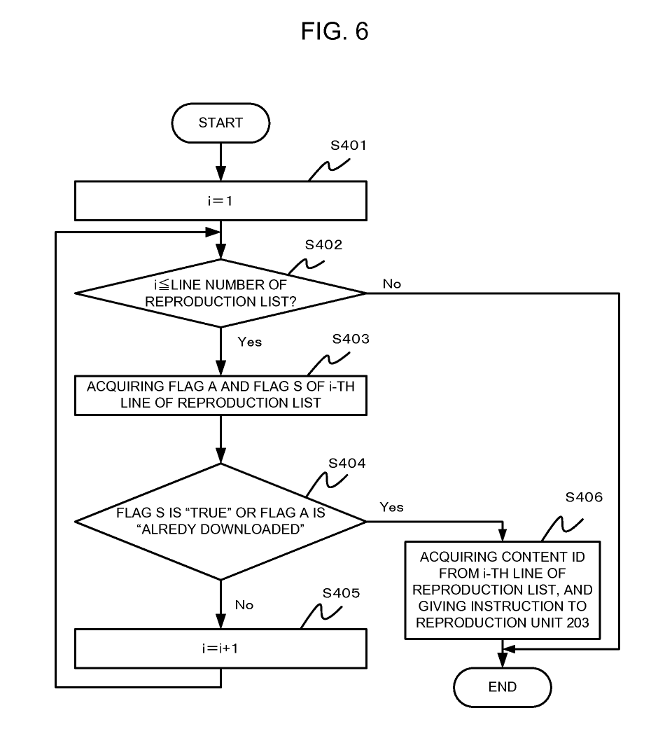

At first, a reproduction operation process of the control unit 202 will be explained by employing FIG. 6. Additionally, in the following explanation, the explanation will be made by employing the case of retrieving the contents that are in a status of being reproducible, and the distribution forms thereof in the descending order of the ranks of the reproduction list, to begin with the highest-rank content.

The control unit 202 initializes a variable i to 1 (step S401). The control unit 202 confirms whether or not the variable i is within the number of lines of the reproduction list (step S402).

When the variable i is not within the number of lines of the reproduction list, the operation is ended. On the other hand, when the variable i is within the number of lines of the reproduction list, the control unit 202 acquires the flag A and the flag S of the i-th-line of the reproduction list (step S403).

The control unit 202 confirms whether the acquired flag A is “Already downloaded”, or the flag S is “True” (step S404). When the acquired flag A is not “Already downloaded”, and yet the flag S is not “True”, the control unit 202 adds 1 to the variable i (step S405), and the operation returns to the step S402. On the other hand, when the acquired flag A is “Already downloaded”, or the flag S is “True”, the control unit 202 determines that the above content is reproducible, gives an instruction of the content ID of the i-th line of the reproduction list to the reproduction unit 203 (step S406), and the operation is ended.

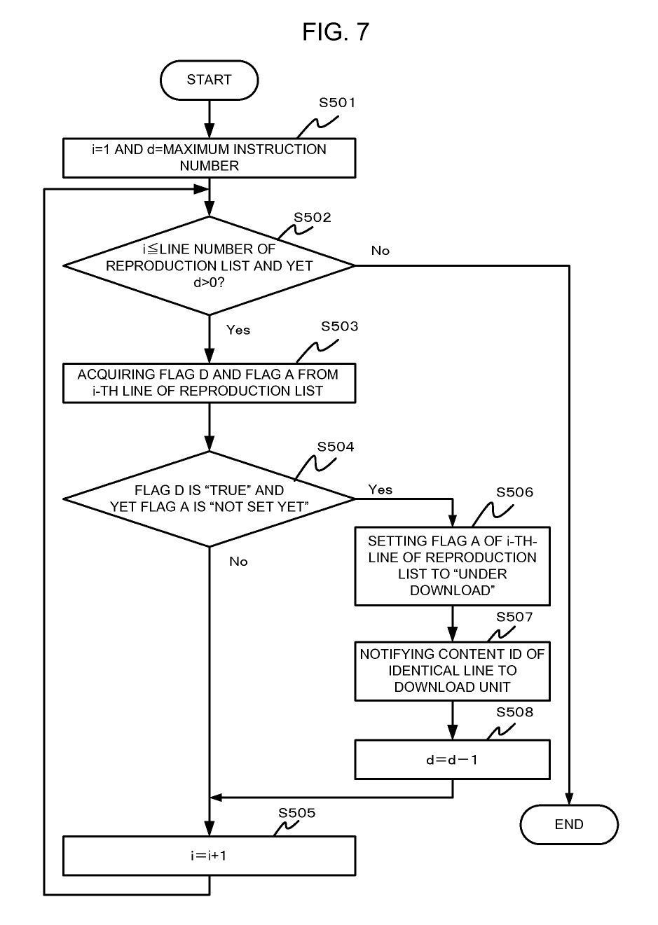

Continuously, the download instruction process will be explained by employing FIG. 7.

The control unit 202 initializes the variable i indicating the reproduction order to 1, and substitutes the content number described in the reproduction list into a variable d as a maximum index number (step S501). The control unit 202 confirms whether the variable i is within the number of lines of the reproduction list, and yet the variable d is positive (step S502).

When the variable i is not within the number of lines of the reproduction list, or the variable d is not positive, the operation is ended. On the other hand, when the variable i is within the number of lines of the reproduction list, and yet the variable d is positive, the control unit 202 acquires the flag D and the flag A of the i-th line of the reproduction list (step S503).

The control unit 202 confirms whether the acquired flag D is “True” and yet the flag A is “Not set yet” (step S504). When the acquired flag D is “True”, and yet the flag A is a flag other than the flag “Not set yet”, the control unit 202 adds 1 to the variable i and the operation returns to the step S502 (step S505).

On the other hand, when the acquired flag D is “True”, and yet the flag A is “Not set yet”, the control unit 202 sets the flag A of the i-th line of the reproduction list to “Under download” (step S506). The control unit 202 notifies the download instruction message including the above content ID to the download unit 204 (step S507). The control unit 202 deducts 1 from the variable d (step S508), and the operation proceeds to the step S505.

The control unit 202 can previously download all contend IDs satisfying the conditions within the reproduction list, dependent on the setting of the variable d in some cases, and can narrow down the number of the contents to be reproduced next into several contents in some cases. Previously acquiring the flag S as well in the step S503 and modifying the condition of the step S504 in such a manner that the flag D is “True”, and yet the flag A and yet the flag S are “False”, respectively, makes it also possible to narrow down the number of the content IDs to be downloaded because the contents do not need to be previously downloaded when the streaming distribution is possible.

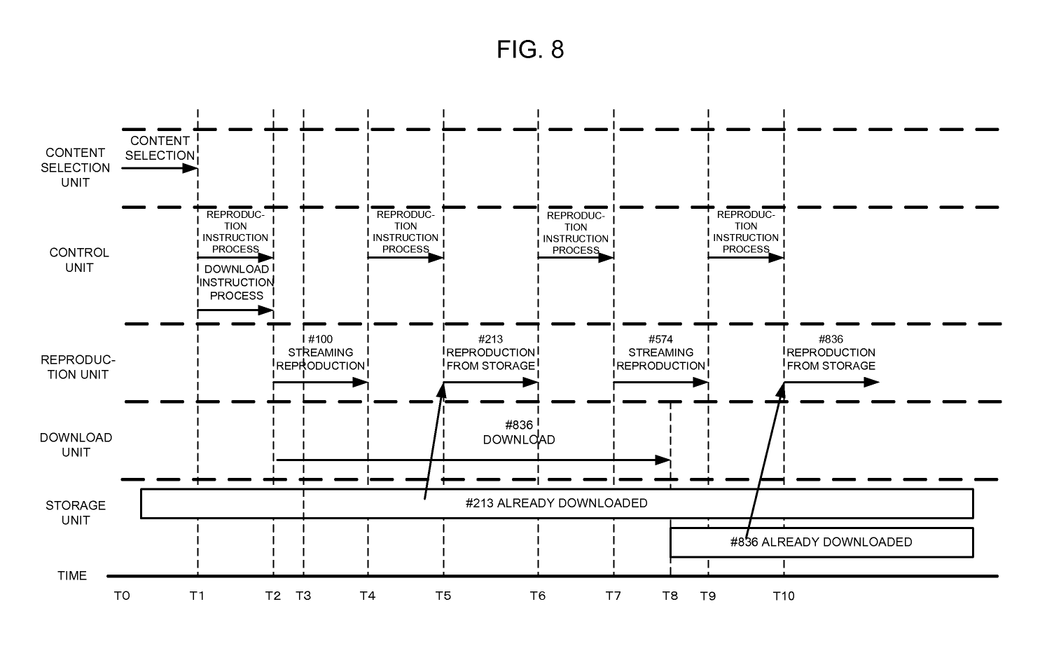

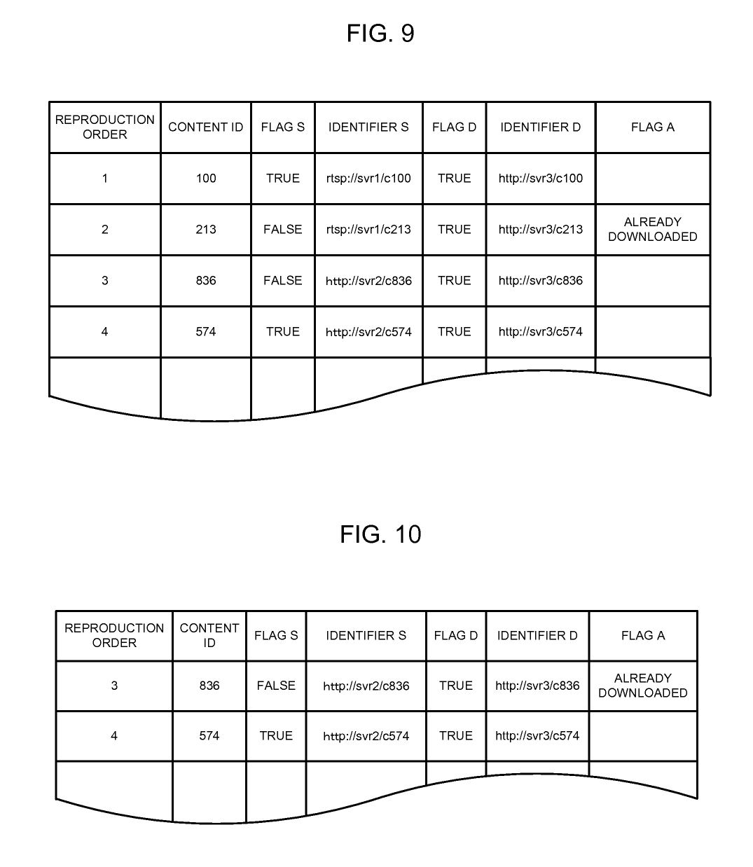

Continuously, an operation of the present invention will be explained by employing the reproduction lists of FIG. 8, FIG. 9, and FIG. 3. Additionally, in the following explanation, the explanation will be made by employing the case of retrieving the contents that are in a status of being reproducible and the distribution forms thereof in the descending order of the ranks of the reproduction list, to begin with the highest-rank content. Additionally, the information related to the contents will be explained by employing the case in which the information provision server provides the information. Further, referencing of the flag S will be explained by employing the case of performing the reference when forming the reproduction list.

The client is activated at a time T0 and makes an access to the information provision server by the user's operation, the contents are selected in the content selection unit 206, and the reproduction list is formed in the memory 201. The control unit 202 inquires of the distribution server of the content described in the identifier S about whether the contents of the reproduction list are streamable. Herein, it is assumed that a content ID #100 and a content ID #574 are streamable. Further, the control unit 202 confirms whether the contents of the reproduction list have been already downloaded into the storage unit 205. Herein it is assumed that a content #213 has been already downloaded in the storage unit 205. The status of the reproduction list at this time is shown in FIG. 9.

The control unit 202 judges that the content #100 corresponds to the streaming distribution and the download distribution because the flag S and the flag D of the content ID #100 of the first line of the reproduction list are “True”, respectively. In addition, the control unit 202 judges that the content is reproduced with the streaming distribution, taking into consideration the fact that the flag A of the content ID #100 to be reproduced in the first place is “Not set yet”, and instructs the reproduction process of the content ID #100.

Further, the control unit 202 judges that the content #213 corresponds to the download distribution because the flag S, the flag D, and the flag A of the content ID #213 of the second line of the reproduction list are “False”, “True”, and “Already downloaded”, respectively. And, the control unit 202 judges that the content is reproduced with the download distribution, taking into consideration the fact that the flag A of the content ID #213 to be reproduced is “Already downloaded”, and instructs the reproduction process of the content ID #213.

Further, the control unit 202 judges that the content #836 corresponds to the download distribution because the flag S and the flag D of the content ID #836 of the third line of the reproduction list are “False”, and “True”, respectively. The control unit 202 takes into consideration the fact that the content ID #836 has not been downloaded yet, and issues the download instruction process.

Further, the control unit 202 judges that the content #574 corresponds to the download distribution and the streaming distribution because the flag S and the flag D of the content ID #574 of the fourth line of the reproduction list are “True” respectively. The control unit 202 judges that with regard to the content ID #574, the above content is reproduced with streaming distribution because the content #574 has not been downloaded yet.

From the above, the control unit 202 instructs the reproduction unit 203 to perform the streaming reproduction of the content #100 in the content reproduction instruction process at a time T1. And, the control unit 202 notifies the download instruction message of the content #836 to the download unit in the download instruction process.

At a time T2, the reproduction unit 203 starts the streaming reproduction of the content #100, and the download unit starts the download of the content #836.

The situation of the reproduction list at a time T3 is shown in FIG. 3.

At a time T4, the reproduction unit 203 ends the reproduction of the content #100, and deletes the content ID #100 from the reproduction list. And, so as to retrieve the contents to be reproduced next, the control unit 202 starts the content reproduction instruction process. And, the control unit 202 instructs the reproduction unit 203 to reproduce the content #213 from the storage unit 205.

At a time T5, the reproduction unit 203 starts the reproduction of the content #213 existing in the storage unit 205.

At a time T6, the reproduction unit 203 ends the reproduction of the content #213, and the control unit 202 starts the next content reproduction instruction process. At this time, originally, the content #836 is listed in the next reproduction order; however, the download thereof has not been completed yet, whereby the control unit 202 instructs the reproduction unit 203 to perform the streaming reproduction of the next content #574.

At a time T7, the reproduction unit 203 starts the streaming reproduction of the content #574.

At a time T8, the download is completed, and the content #836 is stored in the storage 205. The reproduction list at this time is shown in FIG. 10.

At a time T9, the reproduction unit 203 ends the reproduction, and the control unit 202 starts the next content reproduction instruction process. This time, the control unit 202 instructs the reproduction unit 203 to reproduce the content #836 from the storage unit 205 because the content #836 that has not been reproduced yet exists.

At a time T10, the reproduction unit 203 starts the reproduction of the content #836 existing in the storage unit 205.

As described above, in the present invention, the user does not need to select a classification of the distribution form by keeping the reproduction list that is comprised of the content IDs selected by the user, and retrieving the already downloaded content or the streamable content as the reproducible content within the reproduction list.

Further, determining whether or not the streaming distribution is possible from the situation of the distribution server resources and network resources makes it possible to maintain a high-quality service. Also when the streaming distribution becomes impossible, the user can view the already downloaded contents. There is no possibility that the user encounters a decline in the quality in a series of the views.

The present invention downloads the contents when the streaming distribution becomes impossible; however, it is also possible to perform the download in the day. Positively performing this enables leveling of the traffic of the video content distribution and a reduction in a facility cost of both of the network and distribution server.

Preserving the reproduction list in a special management server enables the reproduction list to be shared over a plurality of the clients. The reproducible content sometimes differs among the clients that share the production list because the reproducible content is determined client by client. For example, the client receiving only a limited service such as a wireless connection has fewer reproducible contents as compared with the client connected to an optical fiber. However, the former can continuously view the interesting contents, and the user does not need to be aware of the connection situation particularly.

The first exemplary embodiment can provide the video content distribution system that eliminates the selection of the distribution form that is intrinsically unnecessary, and allows the convenience to be compatible with the quality while suppressing the cost.

### Second Exemplary Embodiment

The second exemplary embodiment of the present invention will be explained.

The above-mentioned client was explained by employing a configuration of providing the service having the VOD service and the download service integrated therein. In this exemplary embodiment, a configuration of further integrating the linear service with the above service will be explained. Additionally, identical codes are affixed to components similar to those of the above-mentioned exemplary embodiment, and the detailed explanation is omitted.

So as to integrate the linear service, a live program list is introduced, and is previously stored in the memory 201 of the client. A configuration is made so as to store the live program list in the content ID, and to incorporate the start time, the flag S, the flag D, flag A, the identifier S, and the identifier D into the content ID as the attributes.

The control unit 202 compares the current time with the start time within the live program list. When the content ID of which the reproduction start time comes is present as a result of the comparison, the control unit 202 deletes the above content ID from the live program list, and adds it as a leading order rank to the reproduction list, or adds it to the reproduction list and set the dependence content ID to it. At this time, the control unit 202 writes the flag S, the flag D, flag A, the identifier S, and the identifier D in the reproduction list, and executes the reproduction instruction process. Then, the control unit 202 defines the content newly written in the reproduction list as the content that should be reproduced and retrieves it, and instructs the reproduction unit 203 to perform the reproduction instruction process. With this, the reproduction of the content that was so far under reproduction is restarted after the live program is ended. Or, the content that was under reproduction may be reproduced from the beginning.

While the explanation was made by employing the case of separately providing the reproduction list and the live program list, a configuration of adding the start time to the reproduction list as the attribute may be used.

As mentioned above, the user does not need to select a classification of the distribution form and a classification of the service by combining the reproduction list and the live program list.

### Third Exemplary Embodiment

The third exemplary embodiment of the present invention will be explained.

The above-mentioned client was explained by employing a configuration of providing the service having the VOD service, the download service, and the linear service integrated therein. In this exemplary embodiment, a configuration of further integrating an emergent broadcast service will be explained. Additionally, identical codes are affixed to components similar to those of the above-mentioned exemplary embodiment, and the detailed explanation is omitted.

An emergent broadcast list is stored in the memory 201 of the client. At first, an identifier E including a name of the distribution server in which the emergent broadcast is performed, a protocol name, and a content name is incorporated into the emergent broadcast list.

The client includes a detection unit that detects that the emergent broadcast is performed, for example, by periodically making an access to the information server etc. in some cases and receiving data indicating that the emergent broadcast is performed in some cases.

When the detection unit detects the start of the emergent broadcast, the control unit 202 generates the content ID of the emergent broadcast, and sets the text of the identifier E of the emergent broadcast list to the identifier S of the reproduction list, and “True” to the flag S, respectively. Further, the control unit 202 adds the content ID of the emergent broadcast list as a leading order rank to the reproduction list. Or, the control unit 202 adds it to the reproduction list and sets the dependent content ID to it. And, the control unit 202 executes the reproduction instruction process. Then, the control unit 202 defines the content newly written in the reproduction list as the content that should be reproduced and retrieves it, and instructs the reproduction unit 203 to reproduces the above content. The reproduction of the content that was so far under reproduction is restarted after the emergent broadcast is ended. Or, the content that was under reproduction may be reproduced from the beginning.

As mentioned above, in accordance with the present invention, the user does not need to select the emergent broadcast.

Additionally, while it is possible to configure the above-mentioned client and server of the present invention with hardware as apparent from the above-mention explanation, it is also possible to realize them with a computer program. In such a configuration, functions and operations similar to those of the above-described embodiments are realized with a processor that operates under a program stored in a program memory. Additionally, it is also possible to realize only one part of the functions of the above-described exemplary embodiments with the computer program.

Above, although the present invention has been particularly described with reference to the preferred embodiments and the examples, it should be readily apparent to those of ordinary skill in the art that the present invention is not always limited to the above-mentioned embodiment and examples, and changes and modifications in the form and details may be made without departing from the spirit and scope of the invention.

(Supplementary Note 1)

A terminal characterized in including:

a retrieval means that acquires from a server information of a distribution form to which each content of a content list in which identification information of contents to be reproduced in the terminal is shown can correspond, and retrieves a pair of the content that is in a status of being reproducible, and the distribution form thereof, based on the aforementioned acquired information of the distribution form and a situation of reproduction readiness of the contents for each distribution form; and

a reproduction means that reproduces the aforementioned retrieved content by employing the aforementioned retrieved distribution form.

(Supplementary Note 2)

A terminal according to the supplementary note 1, characterized in that the aforementioned retrieval means acquires whether the aforementioned distribution form of each content is any of streaming and download, and retrieves the content of which the aforementioned distribution form is the streaming, or the content of which the aforementioned distribution form and the aforementioned situation of the reproduction readiness is the download and is a situation in which the download of the content has been ended, respectively.

(Supplementary Note 3)

A terminal according to the supplementary note 1 or the supplementary note 2, characterized in including a download means that downloads the contents from the distribution server, wherein when the aforementioned retrieval means retrieves the content of which distribution form and the situation of the reproduction readiness is the download and is a situation of having not been set yet, respectively, it notifies the identification information of the above content to the aforementioned download means.

(Supplementary Note 4)

A terminal according to one of the supplementary note 1 to the supplementary note 3, characterized in including a setting means that inquires of the distribution server for distributing the contents about whether the situation of the reproduction readiness is a situation suitable for the streaming distribution and sets the aforementioned situation of the reproduction readiness when the distribution form of the aforementioned content is the streaming.

(Supplementary Note 5)

A terminal according to the supplementary note 3 or the supplementary note 4, characterized in that the aforementioned download means changes an upper limit speed of the download of the aforementioned content, dependent on a time band.

(Supplementary Note 6)

A terminal according to one of the supplementary note 3 to the supplementary note 5, characterized in that when the contents to be downloaded exist in a plural number, the aforementioned download means simultaneously executes the download for a plurality of the contents within a range of an upper limit number.

(Supplementary Note 7)

A terminal according to one of the supplementary note 1 to the supplementary note 6, characterized in that when a reproduction order has been set to each content of the aforementioned content list, the aforementioned retrieval means retrieves the contents according to the aforementioned reproduction order.

(Supplementary Note 8)

A terminal according to the supplementary note 7, characterized in that after, when a current time reaches at a reproduction start time previously set to the content, the aforementioned retrieval means sets the reproduction order of the above content so that it is listed in a high order rank, it retrieves a pair of the content that is in a status of being reproducible, and the distribution form thereof.

(Supplementary Note 9)

A terminal according to the supplementary note 7, characterized in that after, when an emergent broadcast content exists, the aforementioned retrieval means sets the reproduction order of the aforementioned emergent broadcast content so that it is listed in a high order rank, it retrieves a pair of the content that is in a status of being reproducible, and the distribution form thereof.

(Supplementary Note 10)

A distribution system characterized in including:

a provision means that provides information of a distribution form to which each content of a content list in which identification information of the contents to be reproduced in a terminal is shown can correspond;

a retrieval means that acquires from the aforementioned provision means the information of the distribution form to which each content of the aforementioned content list can correspond, and retrieves a pair of the content that is in a status of being reproducible, and the distribution form thereof, based on the aforementioned acquired information of the distribution form and a situation of reproduction readiness of the contents for each distribution form; and

a reproduction means that reproduces the aforementioned retrieved content by employing the aforementioned retrieved distribution form.

(Supplementary Note 11)

A distribution server characterized in including a provision means that, based on information of a distribution form to which each content of a content list in which identification information of the contents to be reproduced in a terminal is shown can correspond, and a situation of reproduction readiness of the contents for each distribution form, retrieves a pair of the content that is in a status of being reproducible, and the distribution form thereof and provides at least the information of the distribution form, out of the aforementioned information of the distribution form and the situation of the reproduction readiness of the contents for each distribution form, for the terminal that reproduces the aforementioned retrieved content by employing the aforementioned retrieved distribution form.

(Supplementary Note 12)

A distribution server according to the supplementary note 11, characterized in that the aforementioned provision means determines whether or not streaming distribution is possible by employing at least one of the aforementioned distribution situation of the content, a position of a client, and a crowdedness situation of a network, and provides a determination result to the aforementioned terminal as the situation of the reproduction readiness.

(Supplementary Note 13)

A reproduction method characterized in including:

an acquisition step of acquiring from a server information of a distribution form to which each content of a content list in which identification information of the contents to be reproduced in a terminal is shown can correspond;

a retrieval step of retrieving a pair of the content that is in a status of being distributable, and the distribution form thereof, based on the aforementioned acquired information of the distribution form and a situation of reproduction readiness of the contents for each distribution form; and

a reproduction step of reproducing the aforementioned retrieved content by employing the aforementioned retrieved distribution form.

(Supplementary Note 14)

A reproduction method according to the supplementary note 13, characterized in that:

the aforementioned acquisition step acquires whether the aforementioned distribution form of each content is any of streaming and download; and

the aforementioned retrieval step retrieves the content of which the aforementioned distribution form is the streaming, or the content of which the aforementioned distribution form and the aforementioned situation of the reproduction readiness is the download and is a situation in which the download of the content has been ended, respectively.

(Supplementary Note 15)

A reproduction method according to the supplementary note 13 or the supplementary note 14, characterized in including:

a second retrieval step of retrieving the content of which the distribution form and the situation of the reproduction readiness is the download and is a situation of having not been set yet, respectively; and

a download step of downloading the content retrieved by the aforementioned second retrieval step from the distribution server.

(Supplementary Note 16)

A reproduction method according to one of the supplementary note 13 to the supplementary note 15, characterized in including a setting step of inquiring of the distribution server for distributing the contents about whether the situation of the reproduction readiness is a situation suitable for the streaming distribution when the aforementioned distribution form of the content is the streaming, and setting the aforementioned situation of the reproduction readiness.

(Supplementary Note 17)

A reproduction method according to the supplementary note 15 or the supplementary note 16, characterized in that the aforementioned download step changes an upper limit speed of the download of the aforementioned content, dependent on a time band.

(Supplementary Note 18)

A reproduction method according to one of the supplementary note 15 to the supplementary note 17, characterized in that when the contents to be downloaded exist in a plural number, the aforementioned download step simultaneously executes the download for a plurality of the contents within a range of an upper limit number.

(Supplementary Note 19)

A reproduction method according to one of the supplementary note 13 to the supplementary note 18, characterized in that when a reproduction order has been set to each content of the aforementioned content list, the aforementioned retrieval step retrieves the contents according to the aforementioned reproduction order.

(Supplementary Note 20)

A production method according to the supplementary note 19, characterized in including a step of, after, when a current time reaches at a reproduction start time previously set to the content, setting the reproduction order of the above content so that it is listed in a high order rank, retrieving a pair of the content that is in a status of being reproducible, and the distribution form thereof.

(Supplementary Note 21)

A reproduction method according to the supplementary note 19, characterized in including a step of, after, when an emergent broadcast content exists, setting the reproduction order of the aforementioned emergent broadcast content so that it is listed in a high order rank, retrieving a pair of the content that is in a status of being reproducible, and the distribution form thereof.

(Supplementary Note 22)

A program of a terminal, characterized in that the aforementioned program causes the aforementioned terminal to execute:

an acquisition process of acquiring from a server information of a distribution form to which each content of a content list in which identification information of the contents to be reproduced in the terminal is shown can correspond;

a retrieval process of retrieving a pair of the content that is in a status of being reproducible, and the distribution form thereof, based on the aforementioned acquired information of the distribution form and a situation of reproduction readiness of the contents for each distribution form; and

a reproduction instruction process of instructing a reproduction unit to reproduce the aforementioned retrieved content by employing the aforementioned retrieved distribution form.

(Supplementary Note 23)

A program of a server, characterized in that the aforementioned program causes the aforementioned server to execute a provision process of, based on information of a distribution form to which each content of a content list in which identification information of the contents to be reproduced in a terminal is shown can correspond, and a situation of reproduction readiness of the contents for each distribution form, retrieving a pair of the content that is in a status of being reproducible, and the distribution form thereof and providing at least the information of the distribution form, out of the aforementioned information of the distribution form and the situation of the reproduction readiness of the contents for each distribution form, for the terminal that reproduces the aforementioned retrieved content by employing the aforementioned retrieved distribution form.

This application is based upon and claims the benefit of priority from Japanese patent application No. 2010-109977, filed on May 12, 2010, the disclosure of which is incorporated herein in its entirety by reference.

### REFERENCE SIGNS LIST

101 distribution server
102 network
103 client
201 memory
202 control unit
203 reproduction unit
204 download unit
205 storage unit
206 content selection unit

What is claimed is:

1. A terminal, comprising:
a retrieval means that acquires from a server information of a distribution form to which each content of a content list in which identification information of contents to be reproduced in the terminal is shown can correspond, and retrieves a pair of the content that is in a status of being reproducible, and the distribution form thereof, based on said acquired information of the distribution form and a situation of reproduction readiness of the contents for each distribution form; and
a reproduction means that reproduces said retrieved content by employing said retrieved distribution form.

2. A terminal according to claim 1, wherein said retrieval means acquires whether said distribution form of each content is any of streaming and download, and retrieves the content of which said distribution form is the streaming, or the content of which said distribution form and said situation of the reproduction readiness is the download and is a situation in which the download of the content has been ended, respectively.

3. A terminal according to claim 1, comprising a download means that downloads the contents from the distribution server, wherein when said retrieval means retrieves the content of which distribution form and the situation of the distribution readiness is the download and is a situation of having not been set yet, respectively, it notifies the identification information of the above content to said download means.

4. A terminal according to claim 1, comprising a setting means that inquires of the distribution server for distributing the contents about whether the situation of the reproduction readiness is a situation suitable for the streaming distribution when said distribution form of the content is the streaming, and sets said situation of the reproduction readiness.

5. A terminal according to claim 3, wherein said download means changes an upper limit speed of the download of said content, dependent on a time band.

6. A distribution system, comprising:
a provision means that provides information of a distribution form to which each content of a content list in which identification information of the contents to be reproduced in a terminal is shown can correspond;
a retrieval means that acquires from said provision means the information of the distribution form to which each content of said content list can correspond, and retrieves a pair of the content that is in a status of being reproducible, and the distribution form thereof, based on said acquired information of the distribution form and a situation of reproduction readiness of the contents for each distribution form; and
a reproduction means that reproduces said retrieved content by employing said retrieved distribution form.

7. A distribution server, comprising a provision means that, based on information of a distribution form to which each content of a content list in which identification information of the contents to be reproduced in a terminal is shown can correspond, and a situation of reproduction readiness of the contents for each distribution form, retrieves a pair of the content that is in a status of being reproducible, and the distribution form thereof and provides at least the information of the distribution form, out of said information of the distribution form and the situation of the reproduction readiness of the contents for each distribution form, for the terminal that reproduces said retrieved content by employing said retrieved distribution form.

8. A reproduction method, comprising:
an acquisition step of acquiring from a server information of a distribution form to which each content of a content list in which identification information of the contents to be reproduced in a terminal is shown can correspond;
a retrieval step of retrieving a pair of the content that is in a status of being distributable, and the distribution form thereof, based on said acquired information of the distribution form and a situation of distribution readiness of the contents for each distribution form; and
a reproduction step of reproducing said retrieved content by employing said retrieved distribution form.

9. A program of a terminal, said program causing said terminal to execute:
an acquisition process of acquiring from a server information of a distribution form to which each content of a content list in which identification information of the contents to be reproduced in the terminal is shown can correspond;
a retrieval process of retrieving a pair of the content that is in a status of being reproducible, and the distribution form thereof, based on said acquired information of the distribution form and a situation of reproduction readiness of the contents for each distribution form; and
a reproduction instruction process of instructing a reproduction unit to reproduce said retrieved content by employing said retrieved distribution form.

10. A program of a server, said program causing said server to execute a provision process of, based on information of a distribution form to which each content of a content list in which identification information of the contents to be reproduced in a terminal is shown can correspond, and a situation of reproduction readiness of the contents for each distribution form, retrieving a pair of the content that is in a status of being reproducible, and the distribution form thereof and providing at least the information of the distribution form, out of said information of the distribution form and the situation of the reproduction readiness of the contents for each distribution form, for the terminal that reproduces said retrieved content by employing said retrieved distribution form.
